(19) United States
(12) Patent Application Publication
(10) Pub. No.: US 2008/0265653 A1
(43) Pub. Date: Oct. 30, 2008

(54) Shoulder Pad for Vehicle Seat

(76) Inventor: Hermann Wetter, Ulm (DE)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 10/599,225

(22) PCT Filed: Mar. 22, 2005
(86) PCT No.: PCT/IB2005/000997

§ 371 Date: Jul. 15, 2008

(30) Foreign Application Priority Data
Mar. 22, 2004 (GB) 0406829.2

(51) Int. Cl. B60R 22/14

(52) U.S. Cl. 297/471

(57) ABSTRACT

The shoulder pad (30) is positioned on the shoulder strap (24) with the thinner projections (40 and 42) in contact with the shoulder of the child (28) and the thicker projections (46, 48 and 50) in contact with the child's chest. In an initial phase of an accident, the friction provided by these relatively thin projections is insufficient to prevent the child's torso from bending forward, thereby reducing the load on the child's neck. During a subsequent phase of the accident, the thicker projections (46, 48 and 50) reach child's shoulder.

The present invention relates to a shoulder pad for a belt of a vehicle seat, particularly though not exclusively a child's safety seat, in which the seat belt forms part of the seat's harness.

Such a shoulder pad is adapted to be mounted on the seat belt for engagement with the shoulder of a user so as to increase the friction between the seat belt and the user's shoulder.

When a vehicle is subject to an accident involving impact from the front, the shoulders of occupants who are retained by seat belts tend to slide forwards relative to the shoulder straps of their seat belts. This results in the heads of such occupants moving forwards relative to the car body, with the possible result of making damaging contact with some part of the car body in front of their seats. It has been proposed to reduce this forward movement by providing shoulder pads on the seat belt shoulder straps that have the effect of increasing the friction between the seat belt and the occupant's clothing. However, in the initial phase of an accident, this can have the effect of subjecting the occupant's neck to unacceptably high forces.

It is an object of the invention to provide an improved shoulder pad for a seat belt.

According to the invention a shoulder pad of the type described above comprises a body having a first zone and a second zone to be mounted on the wearer's side of the seat belt, the second zone being thicker than the first zone.

Suitably the pad is mounted on the wearer's side of the seat belt so that, when the wearer is seated in a normal and substantially erect position, the first zone is located against the wearer's shoulder and the second zone is located at a lower height against a lower part of the wearer's torso.

Preferably the second zone is substantially thicker than the first zone which is suitably of relatively small thickness.

The first and second zones can both be adjacent to the ends of the pad body. The body can have attached to one end, near to the first zone, a tether portion for attachment of the pad to a car seat. The second zone is preferably adjacent to a distal end of the pad body.

Preferably the thickness of the pad increases gradually through the distance from the first zone to the second zone including the zones. The thickness of the pad is suitably appropriate to the seat belt and to the vehicle in which it is to be installed and the difference in thickness between the zones is also suitably selected to be appropriate to the circumstances.

The tapering portion of the shoulder pad, including the two zones, can comprise a thin substrate bearing a series of projections of progressively increasing height. In a preferred pad with projections of progressively increasing height the substrate suitably has a thickness in the range 0.5 to 1.5 mm, particularly 1.0 mm. In such a pad the smaller projections in the first (thinner) zone are suitably 3 to 5 mm (particularly 4 mm) thick, giving a total thickness of substrate and projection in the particular instance of 5 mm. The greater projections in the second (thicker) zone are suitably 8 to 12 mm particularly 10 mm) thick, giving a total thickness of substrate and projection in the particular instance of 11 mm. Preferably the body of the shoulder pad is attached to the tether peripheral stitching.

To help understanding of the invention, a specific embodiment thereof will now be described by way of example and with reference to the accompanying drawings, in which:

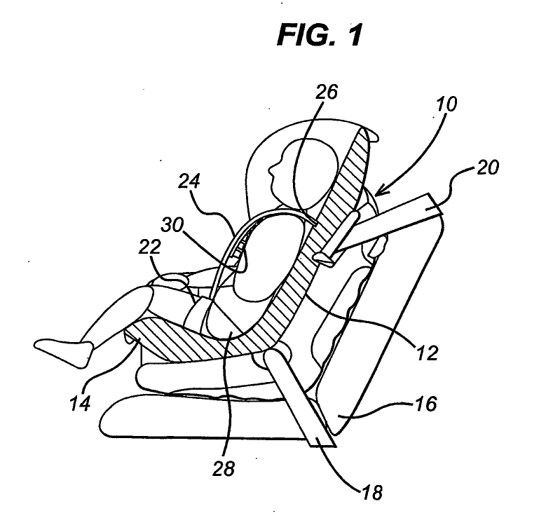

FIG. 1 is a side view of a child safety seat having a harness including a shoulder strap which is fitted with a shoulder pad in accordance with the invention;

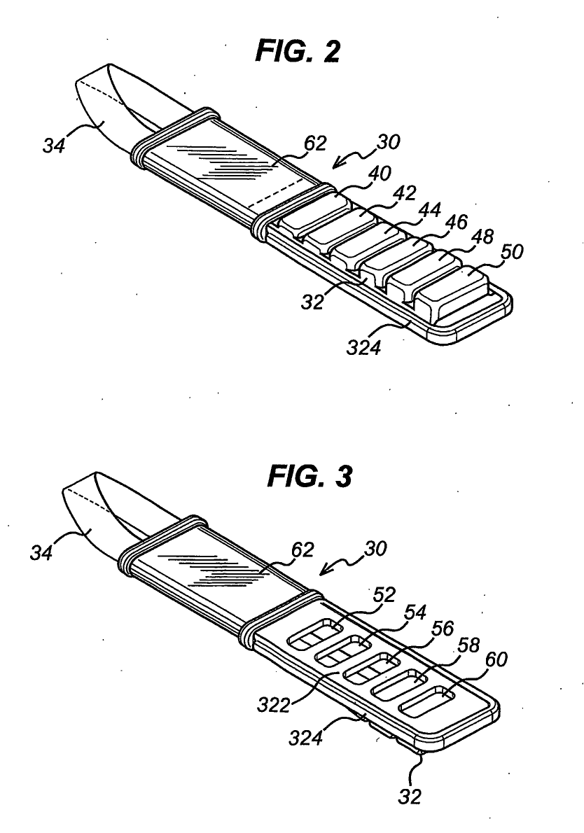

FIG. 2 is a perspective view of the shoulder pad shown in FIG. 1 from the side abutting the child's shoulder in use;

FIG. 3 is a perspective view of the pad shown in FIG. 2 from the other side;

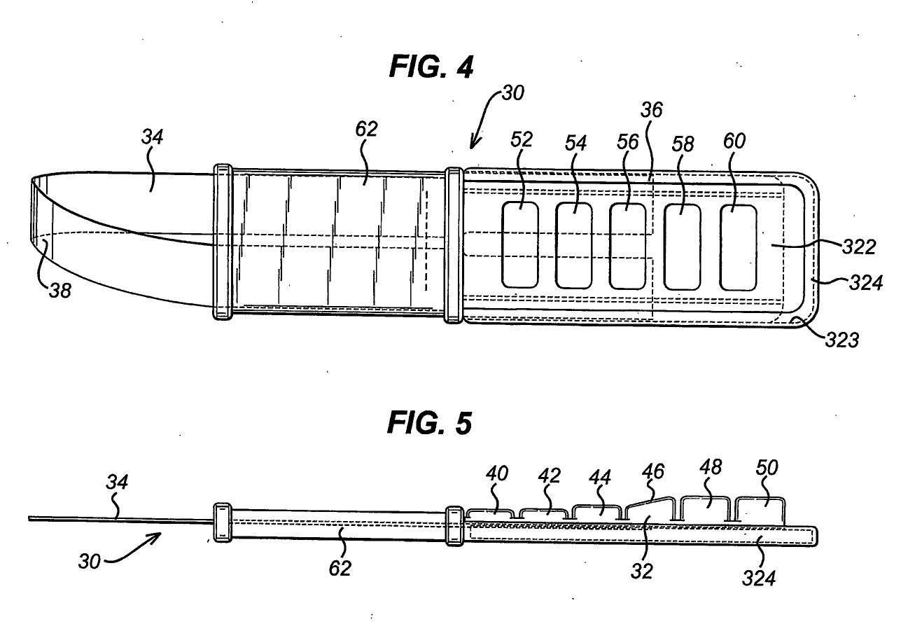

FIG. 4 is a plan view corresponding to FIG. 3 of the shoulder pad;

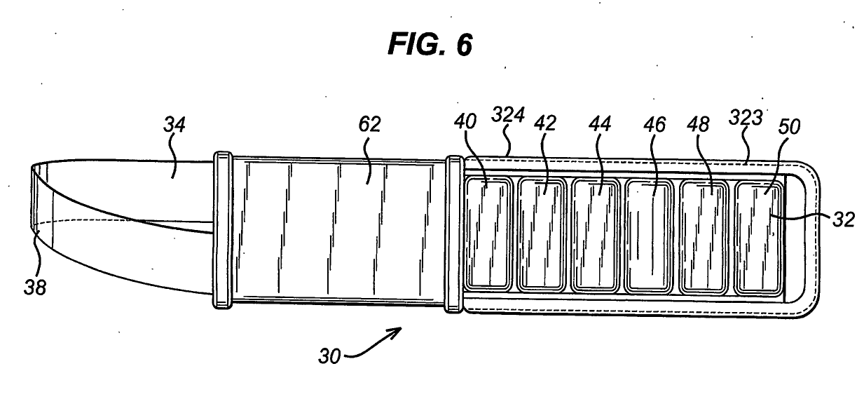

FIG. 5 is a side view of the shoulder pad shown in FIGS. 2 to 4;

FIG. 6 is a plan view corresponding to FIG. 2 of the shoulder pad;

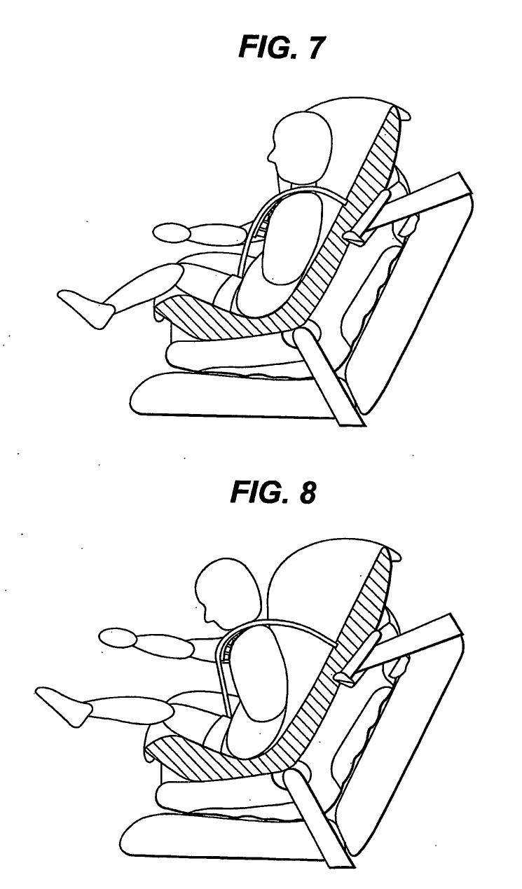

FIG. 7 is a side view, similar to FIG. 1, after an initial phase of an accident;

FIG. 8 is a side view, similar to FIGS. 1 and 7, but after subsequent further movement during an accident.

FIG. 1 shows a child seat 10 having a seat back 12 and a seat portion 14. The child seat 10 is secured on a vehicle seat 10 by means of the lap strap 18 and shoulder strap 20 of a vehicle seat belt. The child seat 10 is equipped with a harness having lap straps 22 and a pair of shoulder straps 24, each of which projects through a respective slot 26 in the seat back 12. The harness restrains a child 28 occupying the seat 10. A shoulder pad 30 in accordance with the invention, is carried on each shoulder strap 24.

Referring to FIGS. 2 to 6, each of the shoulder pads 30 comprises a body 32 formed from stiff resilient material such as synthetic rubber and a perforate retaining strip 322. These are stitched 323 together peripherally, with an edge or binding tape 324. A tether in the form of a doubled back length of narrow strapping 34 is also stitched in, between the body 32 and the retaining strip 322 by the stitching 323. The strapping tether extends from a point 36 mid-way along the body 32 and out of the top end of body and the retaining strip. It passes through sleeve 62, which is also stitched to the strapping. Beyond the sleeve, the tether is arranged on top of the shoulder strap 24 and passes through the slot 26 in the seat back where it is secured by means of a bar (not shown) received in the bight 38 in the tether. The shoulder strap is able to pass freely through the shoulder pad except insofar as both are restrained behind the slot 26.

As can best be seen in FIGS. 2 and 5, the side of the body 32 of the pad facing the child occupant 28 comprises six projections 40 to 50 of thickness that increases progressively from the end from which the tether strap 34 projects. The body is moulded with a relatively dense substrate, typically 1 mm thick, whilst the projections are less dense and extend from the substrate by 4 mm to 10 mm. On the side opposite to the projections 40 to 50, i.e. the side of the shoulder strap opposite from the projections, the perforate retaining strip 322 has a series of five openings 52 to 60 which serve the purpose of increasing the flexibility of the perforate retaining strip 322.

Referring again to FIG. 1, the shoulder pad 30 is positioned on the shoulder strap 24 with the thinner projections 40 and 42 in contact with the shoulder of the child 28 and the thicker projections 48 and 50 in contact with the child's chest. As can be seen from FIG. 7 in an initial phase of an accident, the friction provided by these relatively thin projections is insufficient to prevent the child's torso from bending forward, thereby reducing the load on the child's neck.

During a subsequent phase of the accident, the tether 34 pulls the thicker projections 46, 48 and 50 on to the child's shoulder, as shown in FIG. 8. The resulting increased friction between the shoulder pad and the child's clothes and increased tension in the shoulder straps 24 are sufficient to reduce further forward movement of the child's torso and therefore reduce the total forward movement of the child's head.

1-14. (canceled)

15: A shoulder pad for use with a vehicle seat belt, whereby in use the shoulder pad is for mounting on a wearer's side of the seat belt, the pad having first and second zones, the second zone being thicker in the dimension of the pad orthogonal to the plane of the seat belt used therewith than the first zone, and wherein the first zone is for location against the wearer's shoulder and the second zone is for location at a lower height against a lower part of the wearer's torso when in use the wearer is seated in a normal and substantially erect position.

16: A shoulder pad as claimed in claim 15, wherein the thickness of the pad increases gradually from one end to another end.

17: A shoulder pad as claimed in claim 16, further comprising a thin substrate bearing a series of projections of progressively increasing height between the ends of the pad.

18: A shoulder pad as claimed in claim 15, including a tether portion to connect the pad to a vehicle seat, the tether portion being at the end of the pad adjacent to the first zone.

19: A shoulder pad as claimed in claim 18, including a tether formed of a doubled-back length of narrow strapping material.

20: A shoulder pad as claimed in claim 15, wherein the pad is formed from synthetic rubber.

21. A shoulder pad as claimed in claim 17, and including a tapering portion, which includes the first and second zones, the tapering portion also comprising a thin substrate having a plurality of projections of progressively increasing height.

22: A shoulder pad as claimed in claim 21, wherein the substrate has a thickness in the range of about 0.5 to about 1.5 mm.

23: A shoulder pad as claimed in claim 21, wherein the projections in the first zone are between about 3 to about 5 mm thick and result in a total thickness of substrate and projection of about 5 mm; and further wherein the projections in the second zone are between about 8 to about 12 mm, and result in a total thickness of substrate and projection of about 11 mm.

24: A shoulder pad as claimed in claim 15, wherein the pad is attached to a tether for connecting the pad to a vehicle seat.

25: A vehicle seat belt for engagement with the shoulder of a user, including a shoulder pad as claimed in claim 15.

26: A child car safety carrier having a harness with at least one shoulder strap, including a shoulder pad as claimed in claim 15.
